(19) United States
(12) Patent Application Publication
(10) Pub. No.: US 2014/0218579 A1
(43) Pub. Date: Aug. 7, 2014

(54) Image Capture Device with Shared Focusing Mechanism

(71) Applicants: Asia Optical International Ltd., Tortola (GB); Sintai Optical (Shenzhen) Co., Ltd., Shenzhen City (CN)

(72) Inventor: Chun-Yu Hsueh, Taichung (TW)

(73) Assignees: Asia Optical International Ltd., Tortola (GB); Sintai Optical (Shenzhen) Co., Ltd., Shenzhen City (CN)

(21) Appl. No.: 14/172,982

(22) Filed: Feb. 5, 2014

(30) Foreign Application Priority Data
Feb. 6, 2013 (TW) 102202525

(51) Int. Cl. G02B 7/04; H04N 5/225

(52) U.S. Cl. CPC G02B 7/04; H04N 5/2254
USPC 348/308; 348/345; 348/311

(57) ABSTRACT

An image capture device includes a focusing mechanism, a plurality of lenses, and an image sensing element. The lenses are driven by the focusing mechanism to perform focus operation. The image sensing element selectively receives an image through one of the lenses.

### BACKGROUND OF THE INVENTION

1. Field of the Invention

The invention relates to an image capture device with a shared focusing mechanism.

2. Description of the Related Art

Conventionally, an image capture device with a zoom function is thinned by containing plural lenses of different focal lengths rather than containing a single zoom lens, wherein each of the lenses is provided with a focusing mechanism to perform focusing operation. Thus, an image capture device includes a plurality of focusing mechanisms. Such an arrangement, however, results in increased cost and complexity in mechanical structure.

### BRIEF SUMMARY OF THE INVENTION

To address the shortcomings discussed, the invention provides an image capture device, wherein the lenses jointly use a focusing mechanism rather than respectively use one. By this arrangement, the focusing mechanism and the lens switching mechanism are simplified and the manufacturing cost is reduced.

The image capture device in accordance with an exemplary embodiment of the invention includes a focusing mechanism, a plurality of lenses, and an image sensing element. The lenses are driven by the focusing mechanism to perform focus operation. The image sensing element selectively receives an image through one of the lenses.

In another exemplary embodiment, the image capture device further includes a zoom driving element configured to drive the lenses so that the focusing mechanism is connected to the one of the lenses to perform the focus operation.

In yet another exemplary embodiment, the image capture device further includes a focus driving element configured to drive the focusing mechanism so that the focusing mechanism is connected to the one of the lenses to perform the focus operation.

In another exemplary embodiment, the image capture device further includes a plurality of resilient elements disposed around the lenses.

In yet another exemplary embodiment, the lenses have focal lengths different from each other.

In another exemplary embodiment, the lenses are arranged in a line.

In yet another exemplary embodiment, the lenses are arranged in a circle.

In another exemplary embodiment, the image sensing element is a charge coupled device.

In yet another exemplary embodiment, the image sensing element is a complementary metal oxide semiconductor device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts an image capture device with a shared focusing mechanism element in accordance with an embodiment of the invention, wherein a lens module is in use;

FIG. 2 depicts an image capture device with a shared focusing mechanism element in accordance with the embodiment of the invention, wherein another lens module is in use; and

FIG. 3 depicts an image capture device with a shared focusing mechanism element in accordance with the embodiment of the invention, wherein another lens module is in use.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

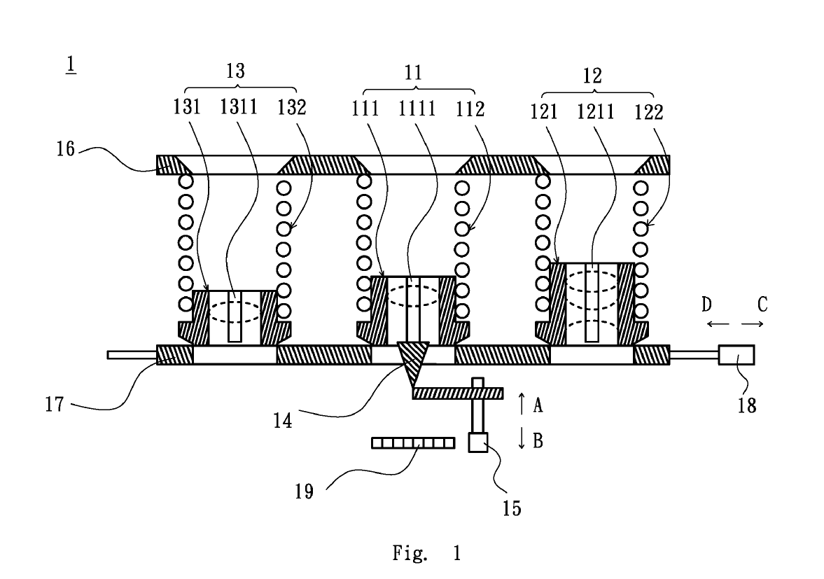

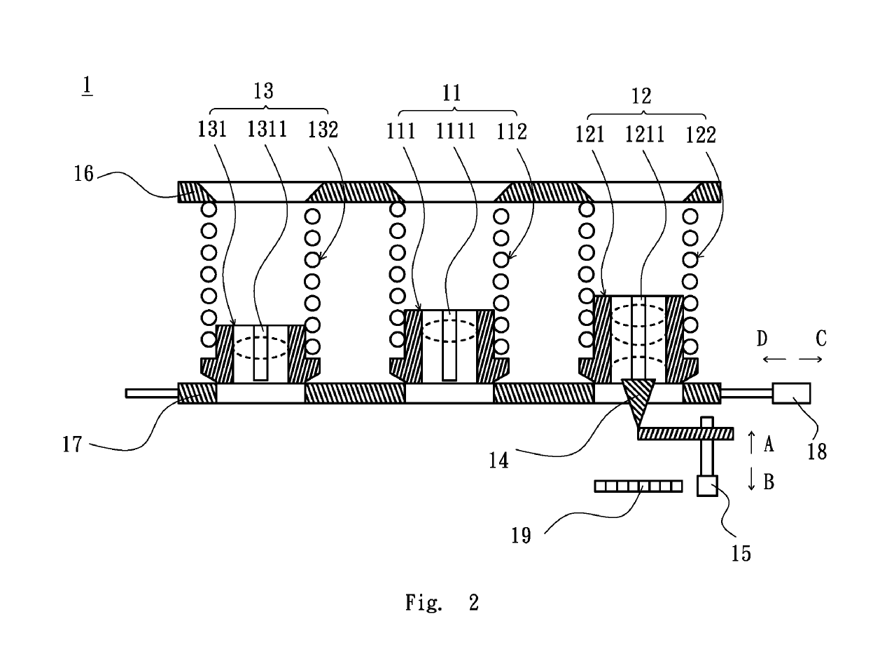

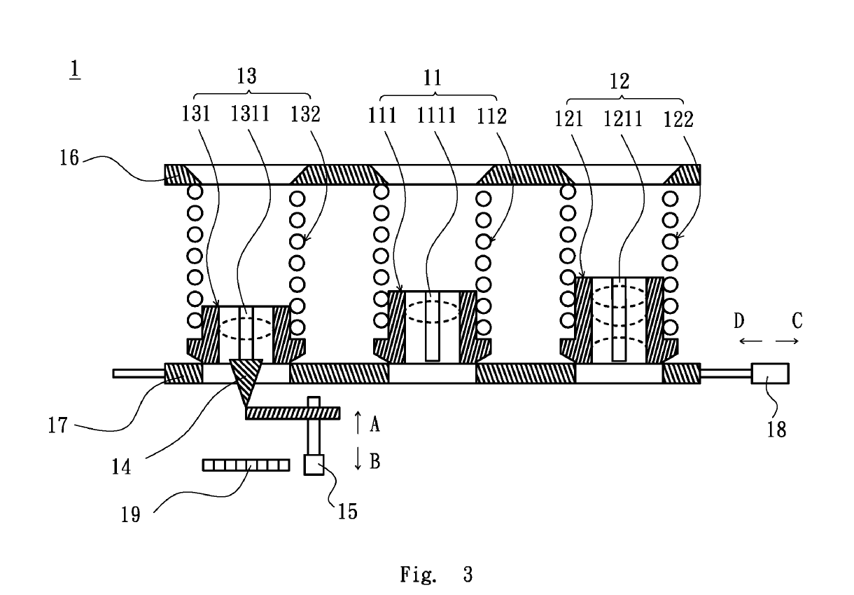

Referring to FIG. 1, in an embodiment of the invention, an image capture device 1 includes a plurality of lens modules 11, 12, 13 which have different effective focal lengths and jointly use a focusing mechanism 14. In zooming operation, the lens modules 11, 12, 13 can be switched so that the focusing mechanism 14 is connected to the lens module 11, 12, or 13. Specifically, the focusing mechanism 14 can be connected to the lens module 11 as shown in FIG. 1, connected to the lens module 12 as shown in FIG. 2, and connected to the lens module 13 as shown in FIG. 3.

In this embodiment, the lens modules 11, 12, 13 are disposed in a line on a fixing plate 17 and fixed by a clamping cap 16. A zoom driving element 18 is connected to the fixing plate 17. In zooming operation, the lens modules 11, 12, 13 are driven by the zoom driving element 18 through the fixing plate 17, to move in direction C or D.

The lens module 11 includes a lens 111 and a spring 112, wherein the lens 111 includes a connecting element 1111. Referring to FIG. 1, the focusing mechanism 14 is connected to the connecting element 1111 of the lens 111 when the lens module 11 is selected to capture an image. The focusing mechanism 14 is driven by the focus driving element 15 for moving the lens 111 in direction A or B to perform focusing operation. The spring 112 is disposed around the lens 111 and propped against the clamping cap 16 to eliminate the backlash during movement of the lens 111 in direction B. The image sensing element 19 is directed at the lens module 11 to receive an optical image captured by the lens module 11 and convert the optical image into an electronic image for output, subsequent image processing, and storage.

The lens module 12 includes a lens 121 and a spring 122, wherein the lens 121 includes a connecting element 1211. The lens module 11 can be replaced with the lens module 12 to capture an image in zooming operation, wherein the focusing mechanism 14 is driven by the focus driving element 15 in direction B and disconnected from the connecting element 1111, the fixing plate 17 is driven by the zoom driving element 18 in direction C to direct the lens module 12 at the image sensing element 19, and the focusing mechanism 14 is driven by the focus driving element 15 in direction A and connected to the connecting element 1211 as shown in FIG. 2. To capture an image by the lens module 12, the focusing mechanism 14 is driven to move in direction A or B to perform focus operation. The spring 122 is disposed around the lens 121 and propped against the clamping cap 16 to eliminate the backlash during movement of the lens 121 in direction B.

The lens module 13 includes a lens 131 and a spring 132, wherein the lens 131 includes a connecting element 1311. The lens module 12 can be replaced with the lens module 13 to capture an image in zooming operation as shown in FIG. 3. Because the zooming operation is similar to the previous zooming operation, the description thereof is omitted.

In this embodiment, the lens modules 11, 12, 13 are disposed in a line on the fixing plate 17. It is understood that the lens modules 11, 12, 13 can be disposed in a circle on the fixing plate, which also belongs to the category of the invention.

In this embodiment, the image sensing element 19 may be a charge coupled device (CCD) or a complementary metal oxide semiconductor (CMOS) device, to receive the optical images through the lens modules 11, 12, 13 and convert the optical images into the electronic images for output, subsequent image processing, and storage.

In conclusion, the invention provides an image capture device, wherein the lens modules jointly use a focusing mechanism rather than respectively use one. Therefore, the designs of the focusing mechanism and the lens switching mechanism are simplified and the manufacturing cost is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capture device, comprising:
a focusing mechanism;
a plurality of lenses driven by the focusing mechanism to perform focus operation; and
an image sensing element selectively receiving an image through one of the lenses.

2. The image capture device as claimed in claim 1, further comprising a zoom driving element configured to drive the lenses so that the focusing mechanism is connected to the one of the lenses to perform the focus operation.

3. The image capture device as claimed in claim 1, further comprising a focus driving element configured to drive the focusing mechanism so that the focusing mechanism is connected to the one of the lenses to perform the focus operation.

4. The image capture device as claimed in claim 1, further comprising a plurality of resilient elements disposed around the lenses.

5. The image capture device as claimed in claim 1, wherein the lenses have focal lengths different from each other.

6. The image capture device as claimed in claim 1, wherein the lenses are arranged in a line.

7. The image capture device as claimed in claim 1, wherein the lenses are arranged in a circle.

8. The image capture device as claimed in claim 1, wherein the image sensing element is a charge coupled device.

9. The image capture device as claimed in claim 1, wherein the image sensing element is a complementary metal oxide semiconductor device.
